(19) United States
(12) Patent Application Publication
(10) Pub. No.: US 2005/0170849 A1
(43) Pub. Date: Aug. 4, 2005

(54) Silent mode system and method for portable devices with audible alarm

(76) Inventor: Todd A. McClelland, Corvallis, OR (US)

Correspondence Address: AGILENT TECHNOLOGIES, INC.;Legal Department; DL429, Intellectual Property Administration, P.O. Box 7599, Loveland, CO, 80537-0599, US

(21) Appl. No.: 10/768,603

(22) Filed: Jan. 29, 2004

(51) Int. Cl. H04Q 7/20

(52) U.S. Cl. 455/456.4; 455/567; 455/550.1

(57) ABSTRACT

A portable device with an audible alarm has an audible mode and a silent mode. A silent zone mechanism according to the invention automatically changes the mode of the alarm as the portable device enters or exits a silent zone. Upon entering a silent zone, the silent zone mechanism according to the invention automatically determines that the portable device has entered a silent zone. The silent zone mechanism according to the invention then automatically changes the mode of the alarm to the silent mode. Upon exiting a silent zone, the silent zone mechanism according to the invention automatically determines that the portable device has exited a silent zone. The silent zone mechanism according to the invention then automatically changes the mode of the alarm to the audible mode.

### BACKGROUND OF THE INVENTION

The use of cellular telephones is widespread and pervades into all areas of our society. There is hardly a place in society where one can go, where one does not see people with cellular telephones. Cellular telephones are commonly found in the workplace, in restaurants, in entertainment venues, in sports arenas, in shopping centers, in schools, campuses and universities, in recreation areas, in virtually every venue of society.

While providing convenience and connectivity between people, there are certain situations or environments, where a ringing cellular telephone is an unwanted distraction. One situation or environment, where a ringing cellular telephone is unwanted is in a movie theater. Since the patrons of the movie theater are presumably in the theater to enjoy the movie, a ringing cellular telephone can degrade the movie viewing experience.

For example, a ringing cellular telephone can ruin the theater ambiance, cause the viewer to miss important conversation of the movie, or decrease the overall enjoyment or satisfaction derived from the movie viewing experience. A ringing cellular telephone can also cause embarrassment to the owner of the cellular telephone as they become the object of scorn of the other moviegoers. Furthermore, the majority of patrons of the movie theater intend to place their cellular telephones into a silent mode. However, the patrons often forgot to do so.

Another situation or environment, where a ringing cellular telephone is unwanted is in an auditorium setting, where a speaker may be presenting a seminar or giving a speech. Since the individuals in the auditorium are presumably there to listen to the speaker, a ringing cellular telephone can distract the speaker and the listening audience, and cause embarrassment to the owner of the cellular telephone. For example, the ringing of the cellular telephone can cause the speaker to lose his/her concentration or train of thought or an attendee to miss an important point or key phrase of the presentation.

Consequently, ringing cellular telephones can dilute or possible degrade the overall satisfaction derived from the experience of listening to a speaker's presentation. The majority of attendees of a conference or presentation intend to place their cellular telephones into a silent mode. In fact, prior to the start of a presentation, attendees are often instructed either verbally or in written form (e.g., with a written instruction projected on an overhead screen) to turn off or place their cellular telephones in silent mode. However, inevitably, there are one or more attendees that, for whatever reason, fail to do so and receive a call in the middle of a presentation.

As can be appreciated, it would be desirable to have a mechanism to automatically enforce a “silent zone,” which is an area, such as a movie theater or auditorium, where all the cellular telephones in the area do not ring in the normal audible fashion in response to an incoming call.

Based on the foregoing, there remains a need for a mechanism that automatically enforces a silent zone without user intervention and that overcomes the disadvantages set forth previously.

### SUMMARY OF THE INVENTION

According to one embodiment of the present invention, a silent zone system and method are described. The silent zone system includes a silent zone transmitting unit for generating a silent zone and a silent zone receiving unit that can be disposed in a portable device with an audible alarm. The portable device (e.g., a cellular telephone) includes an alarm with an audible mode (e.g., a ringing mode) and a silent mode. A silent zone mechanism according to the invention automatically changes the mode of the alarm as the portable device enters or exits a silent zone. Upon entering a silent zone, the silent zone mechanism according to the invention automatically determines that the portable device has entered a silent zone. The silent zone mechanism according to the invention then automatically changes the mode of the alarm to the silent mode. Upon exiting a silent zone, the silent zone mechanism according to the invention automatically determines that the portable device has exited a silent zone. The silent zone mechanism according to the invention then automatically changes the mode of the alarm to the audible mode.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a silent zone system according to one embodiment of the invention and a portable communication device entering and exiting the silent zones according to one embodiment of the invention.

FIG. 2 illustrates in greater detail the silent zone transmitter unit of FIG. 1 according to one embodiment of the invention.

FIG. 3 illustrates several exemplary configurations of silent zone transmitters according to one embodiment of the invention.

FIG. 4 is a block diagram illustrating a first exemplary implementation of selected components of the portable device of FIG. 1 according to one embodiment of the invention.

FIG. 5 is a block diagram illustrating a second exemplary implementation of selected components of portable device of FIG. 1 according to another embodiment of the invention.

FIG. 6 is a flowchart illustrating the processing steps performed by the silent zone receiver unit according to one embodiment of the invention.

### DETAILED DESCRIPTION

A silent zone system and methods related thereto are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Silent Zone System 100

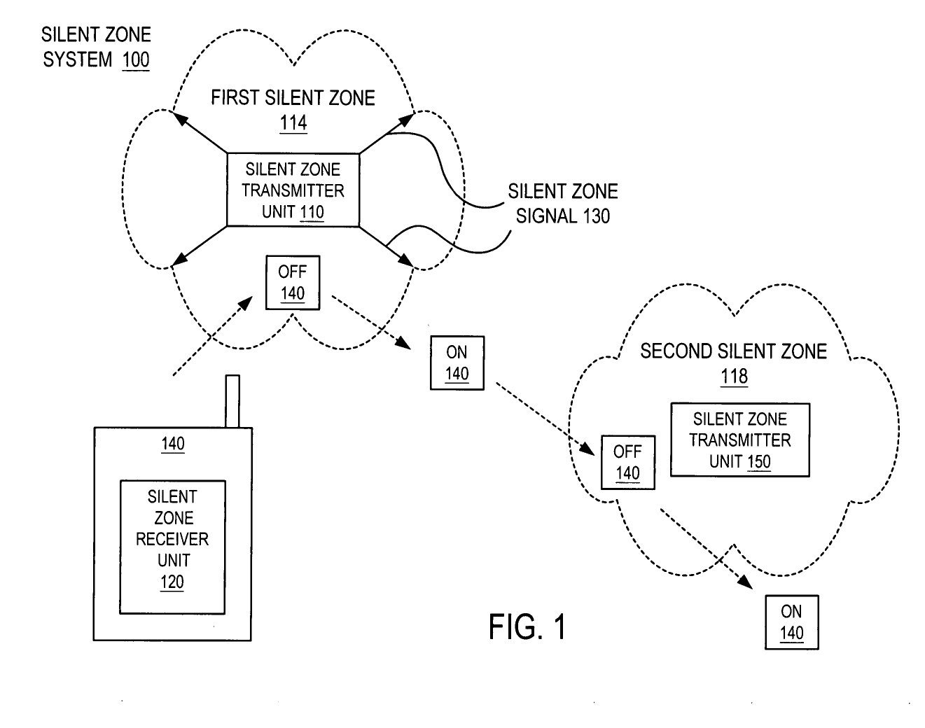

FIG. 1 illustrates a silent zone system (SZS) 100 according to one embodiment of the invention. The silent zone system (SZS) 100 includes a silent zone transmitter unit (SZTU) 110 and a silent zone receiver unit (SZRU) 120. The silent zone transmitter unit (SZTU) 110 generates a first silent zone 114 (e.g., a geographic area that is covered or within range of a silent zone signal 130). The silent zone receiver unit (SZRU) 120 receives the silent zone signal 130 when in range (i.e., when the silent zone receiver unit 120 enters and remains in the silent zone 114).

The silent zone receiver unit (SZRU) 120 can be disposed in a portable device (e.g., a cellular telephone) 140. The portable device 140, for example, can be worn by or carried by a person. As the person moves from one location to another, the portable device 140 can enter and exit different silent zones. For example, the portable device 140 can enter a first silent zone 114, exit the first silent zone, enter a second silent zone 118 and exit the second silent zone 118. The portable device 140 has an audible alarm (e.g., a ring tone) that is disabled or enabled by the silent zone signal 130 as the device 140 enters and exits, respectively, the silent zones.

Upon entering the first silent zone 114, the alarm is disabled or turned “OFF”. Upon exiting the first silent zone 114, the alarm is enabled or turned “ON” until the device 140 enters the second silent zone 118, where the alarm is again disabled or turned “OFF”. Upon exiting the second silent zone 118, the alarm is again enabled or turned “ON”.

The alarm (e.g., speaker/ringer 450 or 596) has an audible mode and a non-audible mode (i.e., a silent mode). The silent mode system and method automatically changes the mode of alarm (e.g., from an audible mode to a silent mode and visa-versa) as the portable devices enter and exit a silent zone.

The silent mode can be, for example, a mode where the owner or the portable device 140 is not notified with an audible alert or alarm (e.g., the ring tone of an incoming call) or a mode where other non-auditory signals (e.g., vibration or lights) are employed in lieu of an audible alert or alarm to notify the owner of an event (e.g., an incoming call or an appointment).

FIG. 1 also illustrates a portable device 140 entering and exiting the silent zones 114, 118 according to one embodiment of the invention. The portable device 140 (1) enters a first silent zone 114 (e.g., a movie theater), (2) exits the first silent zone 114, (3) enters a second silent zone 118 (e.g., an auditorium), and (4) exits the second silent zone 118. The owner of the movie theater can purchase and maintain the first silent zone transmitter unit 110 for creating the first silent zone 114 for the movie theater. Similarly, the owner of the auditorium can purchase and maintain the second silent zone transmitter unit 150 for creating the second silent zone 118 for the auditorium.

Silent Zone Transmitter Unit (SZTU) 110

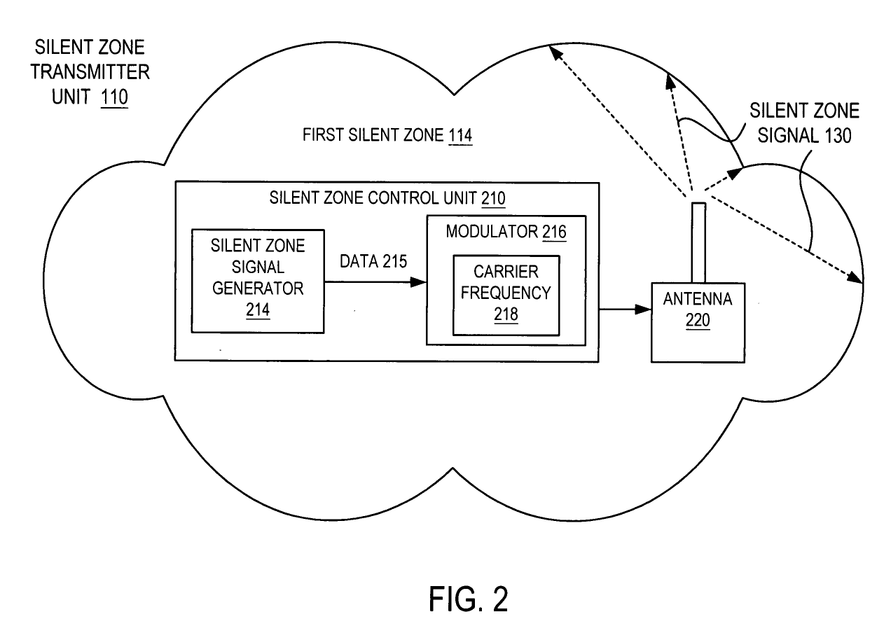

FIG. 2 illustrates in greater detail the silent zone transmitter unit 110 of FIG. 1 according to one embodiment of the invention. The silent zone transmitter unit 110 includes a silent zone control unit 210 (hereinafter also referred to as “transmitter controller”) and an antenna 220 coupled thereto. The transmitter controller 210 includes a silent zone signal generator 214 for generating a data signal 215 (e.g., a single logic high level bit or a logic low level bit). The transmitter controller 210 also includes a modulator 216 for receiving the data signal 215 and modulating a carrier signal 218 with a predetermined frequency with the data signal. The carrier signal 218 that includes the data 215 is then transmitted by the antenna 220 as the silent zone signal 130.

Exemplary Configurations of Silent Zone Transmitters

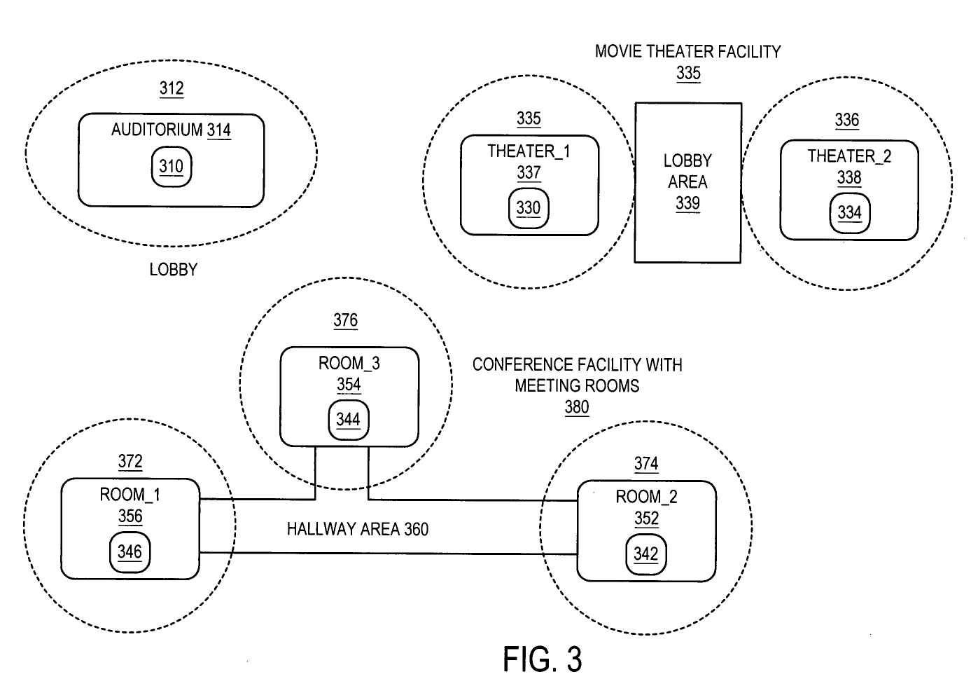

FIG. 3 illustrates several exemplary configurations of silent zone transmitters according to one embodiment of the invention. In a first configuration, a single silent zone transmitter 310 is employed to generate a first silent zone 312 for covering an auditorium 314. In a second configuration, two zone transmitters 330, 334 are employed to generate a second silent zone 335 and a third silent zone 336 for covering two respective theaters 337 and 338 in a movie theater facility 335. In this example, the movie theater facility 335 includes two theaters 337, 338 and a lobby area 339. In a third configuration, three zone transmitters 342, 344, and 346 are employed to generate a silent zone for each conference room (352, 354, 356) in a conference facility 380. For example, a silent zone can be utilized for covering each of the meeting rooms: a first meeting room 356, a second meeting room 352, and a third meeting room 354, respectively. In one embodiment, the hallway area 360 adjacent to these meeting rooms are not covered by a silent zone so that attendees can step into the hallway to make or receive telephone calls. These meeting rooms can be, for example, the rooms in a hotel or other conference facility 380.

In one embodiment, the silent zone transmitter unit 110 sends a continuous silent zone signal 130. Alternatively, the silent zone transmitter unit 110 can periodically send a silent zone signal 130. In either of these two cases, the silent zone receiver unit 120 can be configured to sample the silent zone signal 130 at a predetermined time interval (e.g., every 10 seconds).

Silent Zone Receiver Unit (SZRU) 120

As described previously, the silent zone receiver unit 120 can be disposed or implemented in a portable device 140 that has an audible alarm or alert (hereinafter also referred to as “portable device”). The portable device 140 can be, but is not limited to, a cellular telephone, a personal digital assistant, laptop computers, pocket-sized computers, pagers, watches with alarm, and other electronic devices with audible alarms or audible alerts that can be silenced.

In one embodiment, the silent zone signal 130 is sent with a carrier signal with a predetermined frequency that is different from the frequency employed by the cellular telephone to send and receive calls. The silent zone receiver unit 120 can be configured to receive or tune into the predetermined frequency. In another embodiment, the silent zone signal 130 is integrated into the existing carrier signal and protocols employed by the cellular telephone to send and receive calls. The second embodiment is more complex and perhaps more costly to implement than the first embodiment in that the silent zone signal 130 would need to conform to the requirements set forth by the governmental agencies governing cellular telephone communications and to receive the approval of these same agencies.

When a portable device 140 (e.g., a cellular telephone) is equipped with a silent zone receiver unit 120, the portable device 140 begins to receive the silent zone signal 130 as the device 140 enters into the silent zone 114 and continues to receive the silent zone signal 130 as the device 140 remains in the silent zone 114. When the device 140 exits the silent zone 114, the device 140 is no longer in range of the silent zone signal.

First Exemplary Implementation

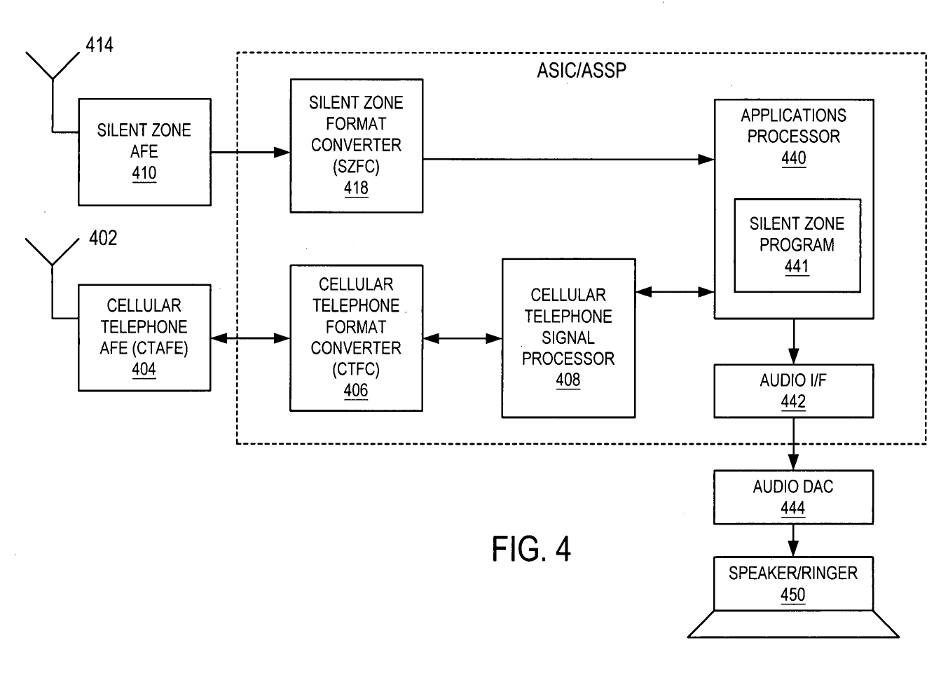

FIG. 4 is a block diagram illustrating a first exemplary implementation of selected components of the portable device 140 of FIG. 1 according to one embodiment of the invention. The portable device 140 includes an antenna 402 for receiving cellular telephone signals, a cellular telephone analog front end (CTAFE) 404, a cellular telephone format converter 406 (hereinafter also referred to as “cellular telephone AFE interface (I/F)”), and a cellular telephone signal processor 408.

The antenna 402 is designed to receive and transmit cellular telephone signals at a predetermined frequency. It is noted that in other embodiments the antenna 402 can be utilized to receive both incoming cellular telephone calls and the silent zone signal 130. In this example, a dedicated, separate antenna 414 is provided for receiving the silent zone signal 130.

The cellular telephone AFE 404 can include well-known front-end analog components for filtering and demodulating the analog signal. The cellular telephone AFE 404 can also include an analog-to digital-converter for converting the analog representation of the telephone signal into a corresponding digital representation of the telephone signal. This digital representation of the telephone signal can then be provided to the cellular telephone signal processor 408.

The portable device 140 includes an applications processor 440 for executing cellular telephone communication programs and a silent zone program 441. The portable device 140 includes an audio interface (I/F) 442 for managing the communication between the applications processor 440 and a separate audio integrated circuit 444 (e.g., an audio digital-to-analog converter (DAC)) that is coupled to a speaker or ringer 450.

The portable device 140 also includes a silent zone receiver unit. The silent zone receiver unit includes an antenna 414, silent zone AFE 410, and a silent zone format converter (SZFC) 418. The antenna 414 is designed to receive the silent zone signal 130 that is transmitted at a predetermined frequency.

The silent zone analog front end 410 is also referred to hereinafter as “silent zone AFE” or “SZAFE”. The SZAFE 410 can include well-known components, such as filters, amplifiers, demodulators and analog-to-digital converters. The SZAFE 410 receives an analog signal from the antenna 414, performs signal processing on the received signal and then converts the analog signal into a corresponding digital signal. The signal processing can include, but is not limited to, signal filtering, signal amplification, signal down-conversion or demodulation.

The silent zone format converter (SZFC) 418 receives the digital signal from the SZAFE 410 in a first format and converts the digital signal into a second format expected by the application processor 440. For example, the SZFC 418 can convert the order of the data and the format or form of the data. For example, a serial bit stream can be converted into a parallel digital format that the application processor 440 can utilize. The format converter 418 also manages the communication protocol between the SZAFE 410 and the format converter 418 and the communication protocol between the format converter 418 and the application processor 440. The format converter 418 can include well-known components, such as buffers, serial-to-parallel converters, and clock generators.

It is noted that functional blocks 406, 408, 418, 440, 442 can be implemented as individual components or as a single integrated circuit, such as an application specific integrated circuit (ASIC) or application specific standard product (ASSP).

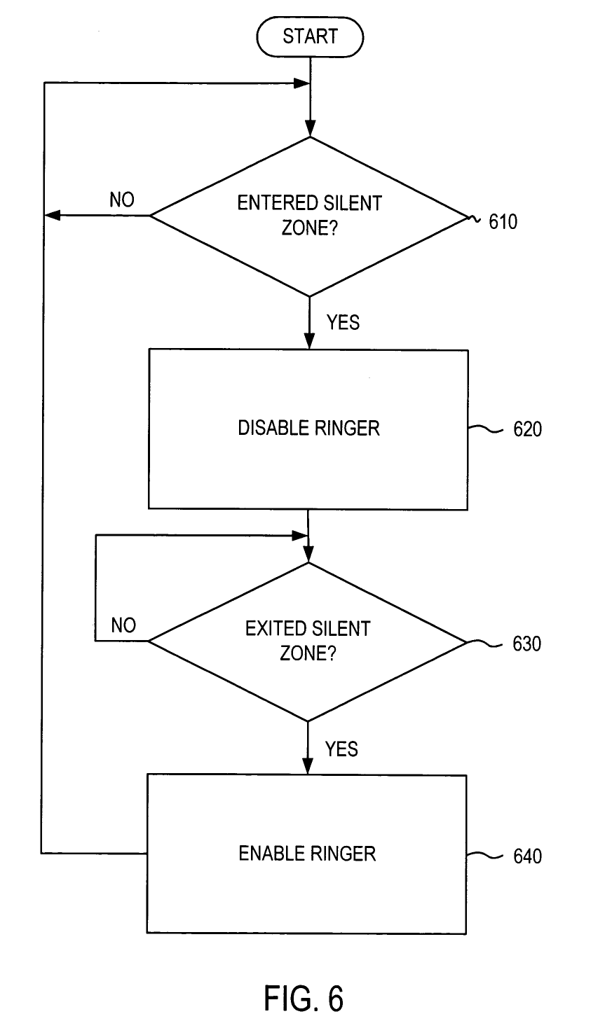

The silent zone receiver also includes a silent zone program 441 that when executed by the application processor 440 performs the processing steps set forth in the flow chart of FIG. 6.

Second Exemplary Implementation

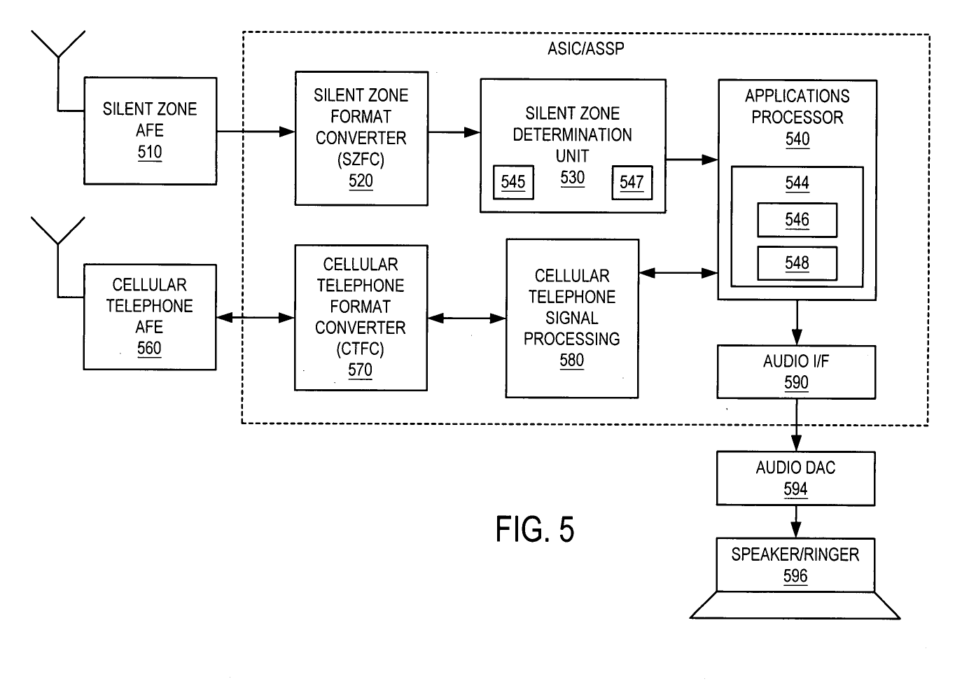

FIG. 5 is a block diagram illustrating a second exemplary implementation of selected components of portable device 140 of FIG. 1 according to one embodiment of the invention. The silent zone receiver includes a silent zone determination unit (SZDU) 530 that is implemented as dedicated hardware in contrast to the implementation illustrated in FIG. 4, where the silent zone determination is implemented as software code 441 executing on the application processor 440.

In this embodiment, the determination or detection of the silent zone signal 130 is performed by hardware. For example, the silent zone determination unit 530 performs the processing steps 610 and 630 set forth in the flow chart of FIG. 6. The determination of the silent zone signal 130 is then provided to the application processor 540 for use to selectively disable or silence the audio alarm or alert.

The silent zone determination unit 530 includes a silent zone exit determination circuit 545 and a silent zone enter determination circuit 547. The silent zone exit determination circuit 545 determines when the portable device with audible alarm (e.g., a cellular telephone) has exited from a silent zone. The silent zone enter determination circuit 547 determines when the portable device has entered into a silent zone.

The silent zone receiver also includes a silent zone program 544 that when executed by the application processor 540 performs the processing steps 620 and 640 set forth in the flow chart of FIG. 6. For example, the silent zone program 544 can include a ring enable module 546 and a ring disable module 548. The ring enable module 546 changes the mode of the portable device into an audible mode (e.g., by enabling the ringer), and the ring disable module 548 changes the mode of the portable device into a silent mode (e.g., by disabling the ringer).

In one embodiment, the silent zone determination unit 530 generates and provides interrupt requests to the application processor 540. Specifically, the silent zone determination unit 530 can generate an exit interrupt request (exit_IRQ) when the portable device exits a silent zone and an enter interrupt request (enter_IRQ) when the portable device enters a silent zone. Alternatively, it is known by those of ordinary skill in the art that a single interrupt request can also be employed instead of two separate interrupt requests to perform the above-described function. In this manner, the application processor 540 can attend to other tasks (e.g., tasks related to cellular telephone communication when the portable device is a cellular telephone) without being burdened in having to continuously poll for the silent zone signal 130.

The application processor 540 can also utilize the audio interface 590 to selectively disable or enable the speaker/ringer 596. Alternatively, in some cellular telephones, the application processor 540 generates a ring signal in order to cause the cellular telephone to ring. In this case, the application processor 540 simply does not generate the requisite signal in response to an incoming call.

The silent zone processing mechanism according to the invention can be implemented with hardware, firmware, software, or a combination thereof. For example, silent zone processing mechanisms can be a microprocessor or micro-controller integrated circuit that executes a program to perform the above-noted functions. Alternatively, silent zone processing mechanism can be implemented as a hard-wired digital circuit that uses digital logic to implement the functions noted previously. For example, the silent zone processing mechanism can be implemented as an application specific integrated circuit (ASIC) or application specific standard product (ASSP).

It is noted that various components can be combined or integrated into a single component to reduce costs, part count, and size requirements. For example, when the silent signal is transmitted at a frequency that is close to the frequency of normal cellular telephone transmissions, a single antenna and analog front end may be employed. Similarly, the silent zone format converter and the cellular telephone format converter the may be combined into a single functional unit or component.

It is noted that the portable device 140 can include other well-known components that are not described herein in order to avoid unnecessarily obscuring the present invention.

Processing Steps

FIG. 6 is a flow chart illustrating the processing steps performed by the silent zone processor according to one embodiment of the invention. In step 610, a determination is made that the portable device with audible alarm (e.g., a cellular telephone) has entered a silent zone. When it is determined that the portable device has not entered a silent zone, the processing remains in step 610. When it is determined that the portable device (e.g., cellular telephone) has entered a silent zone, the processing proceeds to step 620.

In step 620, the silent zone processor automatically disables the speaker or ringer of the portable device. Processing then proceeds to decision block 630. In step 630, a determination is made that the portable device has exited from a silent zone. When it is determined that the portable device has not exited from the silent zone (i.e., the cellular telephone is still in the silent zone), processing remains in step 630. When it is determined that the portable device has exited from the silent zone, processing proceeds to step 640. In step 640, the silent zone processor automatically enables the speaker or ringer. Processing then proceeds to decision block 610. Step 640 can include the sub-step of sending a message to the portable device that an alarm or alert had sounded during the time period that the portable device was in the silent zone.

Although the silent zone mechanisms, silent zone transmitter units, and silent zone receiver units, according to the invention have been described by the various embodiments shown in the figures, other arrangements can be devised in accordance with the teachings of the invention to realize other silent zone mechanisms, silent zone transmitter units, and silent zone receiver units, that automatically changes the mode of a portable device as the device enters into a silent zone and exits from a silent zone.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

1. A portable device comprising:
a) an alarm having an audible mode and a silent mode;
b) a silent zone receiver for receiving a silent zone signal; and
c) a silent zone mechanism for automatically determining that the portable device has entered a silent zone based on the silent zone signal and for automatically changing the mode of the alarm from the audible mode to the silent mode.

2. The device of claim 1 wherein the silent zone receiver includes an antenna, at least one analog front-end component for processing the analog silent zone signal, and a format converter for converting the analog silent zone signal into a corresponding digital version of the silent zone signal.

3. The device of claim 1 wherein the silent zone mechanism automatically determines that the portable device has exited a silent zone and automatically changes the mode of the alarm to the audible mode.

4. The device of claim 2 further comprising:
an applications processor for executing application programs;
wherein the silent zone mechanism includes a silent zone determination unit for selectively generating an interrupt request signal to the applications processor.

5. The device of claim 4 further comprising:
an audio interface;
wherein the applications processor selectively disables the alarm through the audio interface.

6. The device of claim 1 wherein the silent mode includes a vibration mode and a “ringer-off” mode.

7. The device of claim 1 wherein the portable device is a cellular telephone.

8. The device of claim 1 wherein the silent zone mechanism is implemented in an application specific integrated circuit (ASIC), an application specific standard product (ASSP).

9. The device of claim 1 wherein the portable device is one of personal digital assistant, a laptop computer, a pager, a watch with an alarm, and an electronic device with an alarm.

10. A method for selectively silencing a portable device comprising the steps of:
a) providing the portable device with an alarm that includes an audible mode and a silent mode; and
b) automatically changing the mode of the alarm as the device enters and exits from a silent zone.

11. The method of claim 10 wherein the step of automatically changing the mode of the alarm as the device enters and exits from a silent zone includes
a) automatically determining that the portable device has entered a silent zone; and
b) automatically changing the mode of the alarm device to the silent mode.

12. The method of claim 11 wherein the step of automatically determining that the portable device has entered a silent zone includes
a_{—}1) receiving an analog silent mode signal;
a_{—}2) performing analog processing on the silent mode signal;
a_{—}3) converting the analog silent mode signal into a corresponding digital silent mode signal; and
a_{—}4) generating an interrupt request signal based on the digital silent mode signal.

13. The method of claim 11 wherein the step of automatically changing the mode of the alarm as the device enters and exits from a silent zone includes
c) automatically determining that the portable device has exited a silent zone; and
d) automatically changing the mode of the alarm to the audible mode.

14. The method of claim 14 wherein the step of automatically changing the mode of the alarm to the audible mode includes
d_{—}1) changing the mode of the alarm to a predetermined default mode.

15. The method of claim 14 wherein the step of automatically changing the mode of the alarm to the audible mode includes
d_{—}1) changing the mode of the alarm to a normal ringing mode.

16. The method of claim 14 wherein the step of automatically changing the mode of the alarm to the audible mode includes
d_{—}1) restoring the mode of the alarm to a previously set mode prior to entering the silent zone.

17. A silent zone system comprising:
a) a silent zone transmitting unit for generating a silent zone; and
b) a portable device that includes
a. an alarm with an audible mode and a silent mode; and
b. a silent zone receiving unit for automatically determining that the portable device has entered the silent zone and for automatically changing the mode of the alarm from the audible mode to the silent mode.

18. The system of claim 17 wherein the silent zone receiving unit includes an antenna for receiving an analog silent zone signal, at least one analog front-end component for processing the analog silent zone signal, and an analog to digital converter for converting the analog silent zone signal into a corresponding digital version of the silent zone signal.

19. The system of claim 17 wherein the silent zone receiving unit automatically determines that the portable device has exited the silent zone and automatically changes the mode of the alarm to the audible mode.
